(19) United States
(12) Patent Application Publication
(10) Pub. No.: US 2026/0134287 A1
(43) Pub. Date: May 14, 2026

(54) HYPER-PARAMETER TUNING IN GENERATIVE ARTIFICIAL INTELLIGENCE (AI) MODELS USING A HYBRID LARGE LANGUAGE MODEL (LLM)

(71) Applicant: Bank of America Corporation, Charlotte, NC (US)

(72) Inventor: Maharaj Mukherjee, Poughkeepsie, NY (US)

(21) Appl. No.: 18/943,067

(22) Filed: Nov. 11, 2024

(51) Int. Cl. G06N 3/0895

(52) U.S. Cl. CPC G06N 3/0895

(57) ABSTRACT

A computing platform may train, using model management information, a large language model (LLM) adaptation to produce LLM execution strategy information including one or more of: optimization schemes for hyper-parameter optimization, initial sets of parameters, increments at which each parameter would be changed in each iteration, or convergence criteria. The computing platform may converge the LLM by performing hyper-parameter optimization based on the LLM execution strategy information to select a solution space. The computing platform may receive, from a user device, a LLM prompt. The computing platform may input, into the LLM, the LLM prompt, which may cause the LLM to produce a LLM response. The computer platform may send, to the user device, the LLM response and commands directing the user device to display the LLM response, which may cause the user device to display the LLM response causes the user device to display the LLM response.

### BACKGROUND

In some instances, enterprise organizations may utilize large language models (LLMs) to provide information to customers and/or employees (e.g., through chatbots, or the like). In machine learning, hyper-parameter (e.g., parameters whose values may be used to control the learning process) optimization or tuning refers to the problem of choosing a set of optimal hyper-parameters for a learning algorithm. As the number of parameters in a model increases, so does the complexity of the hyper-parameter optimization. For example, for a generative artificial intelligence (AI) model, with millions of parameters, the problem of hyper-parameter optimization may be extremely difficult. Accordingly, it may be important to improve the process through which hyper-parameters are optimized, particularly in generative AI use cases.

### SUMMARY

Aspects of the disclosure provide effective, efficient, scalable, and convenient technical solutions that address and overcome the technical problems associated with training large language models (LLMs). In accordance with one or more embodiments of the disclosure, a computing platform comprising at least one processor, a communication interface, and memory storing computer-readable instructions may train, using model management information, a large language model (LLM) adaptation, which may configure the LLM adaptation model to produce LLM execution strategy information including one or more of: optimization schemes for hyper-parameter optimization, initial sets of parameters, increments at which each parameter would be changed in each iteration, or convergence criteria. The computing platform may train, based on the LLM execution strategy information, a target model type, and target model information, a LLM, which may include converging the LLM by performing hyper-parameter optimization based on the LLM execution strategy information to select a solution space. The computing platform may receive, from a user device, a LLM prompt. The computing platform may input, into the LLM, the LLM prompt, which may cause the LLM to produce a LLM response. The computing platform may send, to the user device, the LLM response and one or more commands directing the user device to display the LLM response, which may cause the user device to display the LLM response.

In one or more instances, the model management information may include model risk management information, model resource management information, model lifecycle management information, model developer notes, model developer communications, model developer meeting notes, or model developer posts. In one or more instances, the LLM execution strategy information may include one or more of: optimization schemes for hyper-parameter optimization, initial sets of parameters, increments at which each parameter would be changed in each iteration, or convergence criteria.

In one or more examples, the LLM may be a specialized LLM, trained based on a foundational LLM. In one or more examples, the LLM execution strategy information may be used to inform convergence of a plurality of LLMs, in addition to the LLM, based on the foundational LLM.

In one or more instances, the computing platform may receive feedback associated with performance of one or more of: the plurality of LLMs or the LLM. The computing platform may identify, based on the feedback, that an error rate of one or more of: the plurality of LLMs or the LLM exceeds an error threshold. The computing platform may execute the LLM adaptation model to produce updated LLM execution strategy information. The computing platform may retrain, using the updated LLM execution strategy information, one or more of: the plurality of LLMs or the LLM.

In one or more examples, training the LLM using the LLM execution strategy information may include training, based on a first portion of the LLM execution strategy information, the LLM, where at least one additional LLM of a plurality of LLMs is trained based on a second portion of the LLM execution strategy information, different than the first portion. In one or more examples, the target model information may be one or more: types of information being used to train the LLM, a volume of the information being used to train the LLM, or limits of the types of information being used to train the LLM.

In one or more instances, training the LLM based on the LLM execution strategy information may reduce a likelihood of flawed convergence of the LLM when compared to training of the LLM without use of the LLM execution strategy information. In one or more instances, training the LLM based on the LLM execution strategy information may improve accuracy of solution space identification, where the hyper-parameter optimization may be performed within the identified solution space, and where performance of the hyperparameter optimization within the identified solution space may reduce a likelihood of errors generated by the LLM when compared to performance of the hyperparameter optimization within other solution spaces identified without use of the LLM execution strategy information.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for tuning hyper-parameters in generative AI models using a hybrid LLM in accordance with one or more example embodiments.

FIGS. 2A-2C depict an illustrative event sequence for tuning hyper-parameters in generative AI models using a hybrid LLM in accordance with one or more example embodiments.

FIG. 3 depicts an illustrative method for tuning hyper-parameters in generative AI models using a hybrid LLM in accordance with one or more example embodiments.

FIG. 4 depicts an illustrative user interface for tuning hyper-parameters in generative AI models using a hybrid LLM in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using a hybrid large language model (LLM) to tune hyperparameters in a generative artificial intelligence (AI) model. In machine learning, hyper-parameter optimization or tuning may refer to choosing a set of optimal hyper-parameters for a learning algorithm. A hyper-parameter may be a parameter whose value may be used to control the learning process, which must be configured before the learning process begins.

Hyper-parameter optimization may determine the set of hyper-parameters that yields an optimal model which minimizes a predefined loss function on a given data set. The objective function may take a set of hyper-parameters and return the associated loss. Cross-validation may be used to estimate this generalization performance, and therefore choose the set of values for hyper-parameters that maximize it.

The complexity of the hyper-parameter optimization may increase exponentially with the number of parameters in the model. For a generative AI model (i.e., with millions of parameters) the problem of hyper-parameter optimization may be extremely difficult. There may be many different methods of hyper-parameter optimization, from exhaustive and brute-force grid search to many other sophisticated methods such as simulated annealing, genetic algorithms, or the like.

None of the above methods may use any lessons learned from previous such attempts of hyper-parameter optimization. Described herein is a system and method that looks for any such lessons learned from previous attempts of hyper-parameter optimization, and uses these lessons learned as rules in a hybrid deep learning method.

A LLM model may look into comments and notes from similar models previously completed with hyper-parameter optimization, and may use the comments to create a strategy on the best way forward to complete the hyper-parameter optimization for the current model in hand. The strategy may include what type of optimization algorithm should be used, the initial set of parameters, the increment at which each parameter should be changed in each iteration, convergence criteria, or the like. As the model progresses along different steps of iterations, the model may be further updated with different rules. If the strategy diverges significantly from the expected behavior from previous lessons learned, the above parameters may be updated using the LLM model and the new strategy may be used.

A large learning model may be a special case of a generative AI model, which may use the same foundation model that may be created from using various forms of data. In a LLM, the foundation model may be adapted for various applications involving questions and responses using natural language processing.

A LLM adaptation model may be created using model specific information resources such as model risk management databases, model resource management databases, model lifecycle management databases, model developer notes, communications, meeting notes, posts, or the like. The type of model being created and the type of data (e.g., volume, limits, or the like) being used may be determined.

The LLM model adaptation may be used to determine, based no the types of model and types of data, 1) the types of optimization scheme to be used for hyper-parameter optimization, 2) the initial set of parameters, 3) the increment with which each parameter may be changed in each iteration, 4) convergence criteria, and/or other information. As the model progresses along different steps of iterations, the model may be further updated with different rules. If the strategy diverges significantly from the expected behavior from previous lessons learned, the above parameters may be updated using the LLM model and the new strategy may be used.

As a result, the LLM may be used to suggest strategies for hyperparameter optimization (i.e., type of optimization scheme to be used, initial values of the parameters to be used, iteration increments, or the like). Model convergence may be analyzed to suggest updated values using the LLM.

These and other features are described in greater detail below.

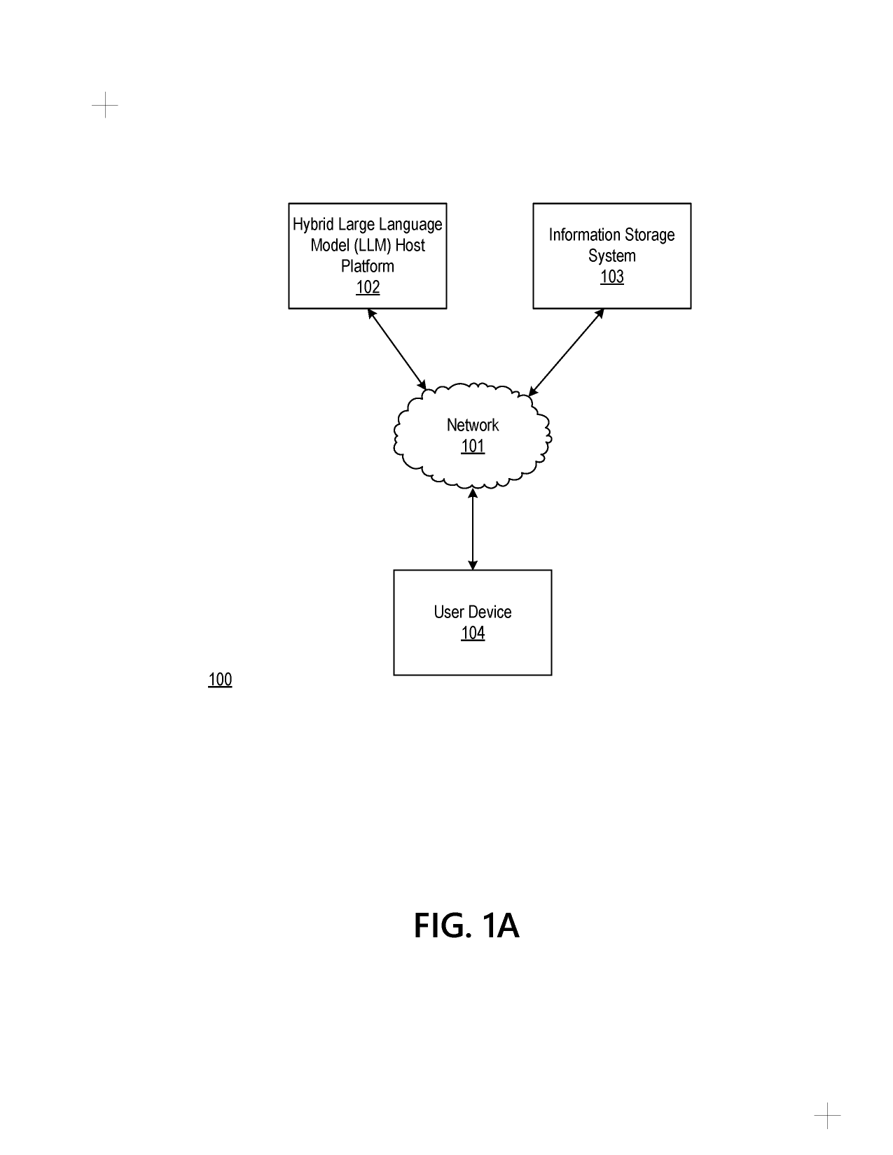

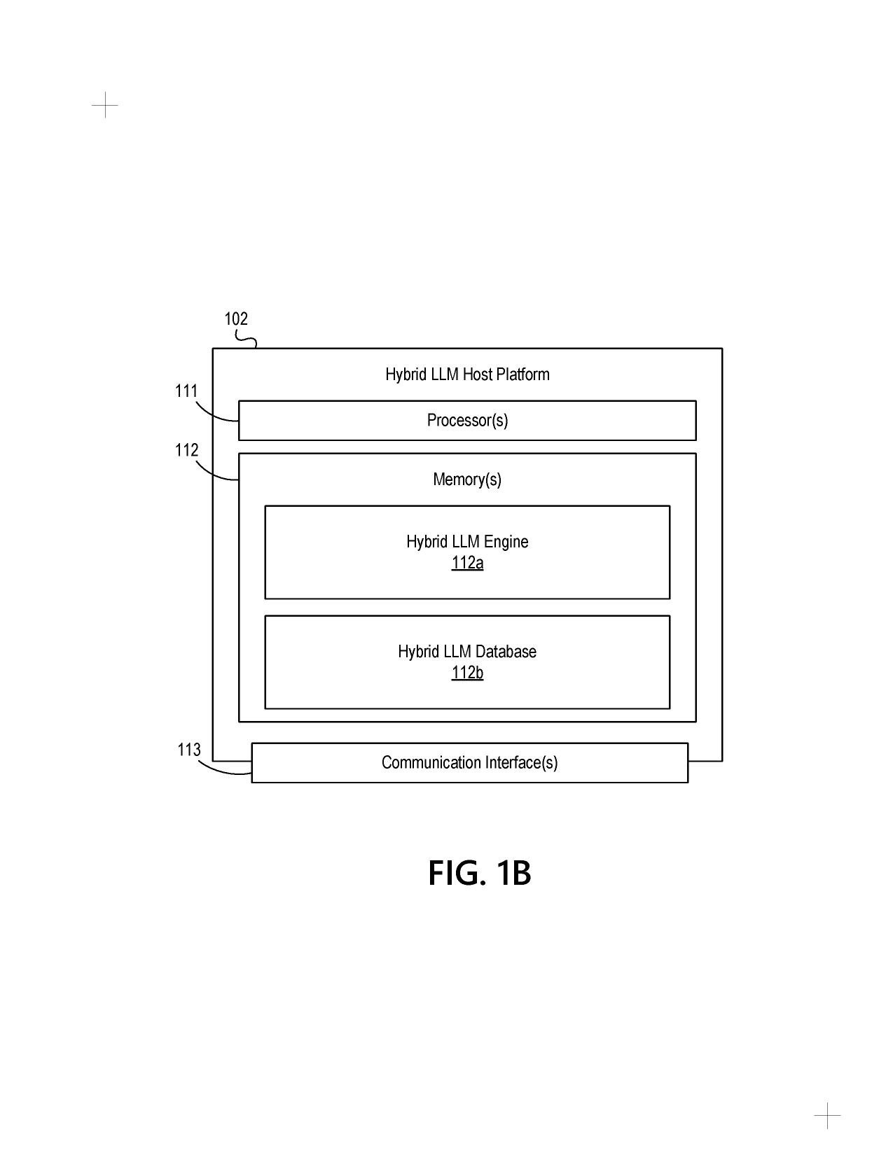

FIGS. 1A-1B depict an illustrative computing environment for tuning hyper-parameters in generative AI models using a hybrid LLM in accordance with one or more example embodiments. Referring to FIG. 1A, computing environment 100 may include one or more computer systems. For example, computing environment 100 may include hybrid LLM host platform 102, information storage system 103, and/or user device 104.

Hybrid LLM host platform 102 may include one or more computing devices (servers, server blades, or the like) and/or other computer components (e.g., processors, memories, communication interfaces, or the like). For example, the hybrid LLM host platform 102 may be configured to train, host, and apply an adaptation of a foundational LLM or AI model, which may be configured to produce LLM execution strategy information (e.g., lessons learned). In some instances, hybrid LLM host platform 102 may converge one or more specific LLMs or AI models (e.g., based on the foundational LLM or AI model) based on the LLM execution strategy information to improve the process of hyperparameter tuning in the specific LLM or AI model.

Information storage system 103 may be or include one or more computing devices (e.g., servers, server blades, or the like) and/or other computer components (e.g., processors, memories, communication interfaces, or the like). For example, information storage system 103 may be configured to store information such as model risk management information, model resource management information, model lifecycle management information, model developer notes, model developer communications, model developer meeting notes, model developer posts, and/or other model specific resource information. In these instances, the information storage system 103 may be configured to send such information to the hybrid LLM host platform 102 for the purpose of training the LLM adaptation model. Any number of such information storage devices may be used to implement the techniques described herein without departing from the scope of the disclosure.

User device 104 may be or include one or more devices (e.g., laptop computers, desktop computer, smartphones, tablets, and/or other devices) configured for use in communicating with a LLM (hosted, e.g., by the hybrid LLM host platform 102). For example, the user device 104 may be used to send LLM prompts/inputs to the hybrid LLM host platform 102, and to receive responses that have been produced by models trained according to lessons learned from the LLM adaptation model. In some instances, the user device 104 may be configured to display one or more graphical user interfaces (e.g., LLM output interfaces, or the like), which may, e.g., be used to provide feedback on LLM outputs. Any number of such user devices may be used to implement the techniques described herein without departing from the scope of the disclosure.

Computing environment 100 also may include one or more networks, which may interconnect hybrid LLM host platform 102, information storage system 103, and user device 104. For example, computing environment 100 may include a network 101 (which may interconnect, e.g., hybrid LLM host platform 102, information storage system 103, and user device 104).

In one or more arrangements, hybrid LLM host platform 102, information storage system 103, and user device 104 may be any type of computing device capable of receiving a user interface, receiving input via the user interface, and communicating the received input to one or more other computing devices, and/or training, hosting, executing, and/or otherwise maintaining one or more artificial intelligence models. For example, hybrid LLM host platform 102, information storage system 103, user device 104, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of hybrid LLM host platform 102, information storage system 103, user device 104 may, in some instances, be special-purpose computing devices configured to perform specific functions.

Referring to FIG. 1B, hybrid LLM host platform 102 may include one or more processors 111, memory 112, and communication interface 113. A data bus may interconnect processor 111, memory 112, and communication interface 113. Communication interface 113 may be a network interface configured to support communication between hybrid LLM host platform 102 and one or more networks (e.g., network 101, or the like). Memory 112 may include one or more program modules having instructions that when executed by processor 111 cause hybrid LLM host platform 102 to perform one or more functions described herein and/or one or more databases that may store and/or otherwise maintain information which may be used by such program modules and/or processor 111. In some instances, the one or more program modules and/or databases may be stored by and/or maintained in different memory units of hybrid LLM host platform 102 and/or by different computing devices that may form and/or otherwise make up hybrid LLM host platform 102. For example, memory 112 may have, host, store, and/or include hybrid LLM engine 112a and hybrid LLM database 112b. Hybrid LLM host engine 112a may have instructions that direct and/or cause hybrid LLM host platform 102 to execute advanced techniques to converge LLMs and/or AI models. For example, the hybrid LLM engine 112a may train, deploy, and/or otherwise refine models through both initial training (including hyper-parameter optimization based on lessons learned from model adaptations) and one or more dynamic feedback loops which may, e.g., enable continuous improvement of the models and further optimize the models in output generation. Hybrid LLM database 112b may store information that may be used by the hybrid LLM host platform 102 and/or hybrid LLM engine 112a to effectively generate LLM outputs.

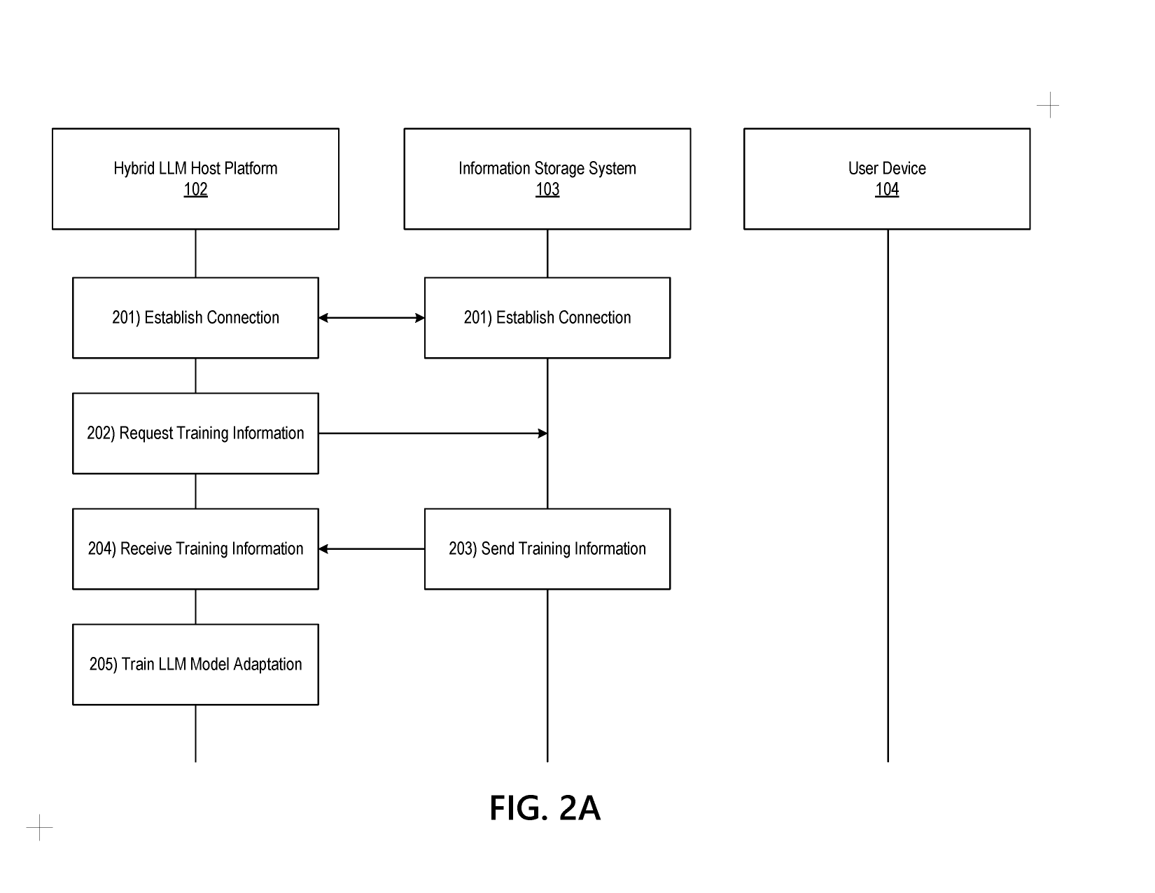

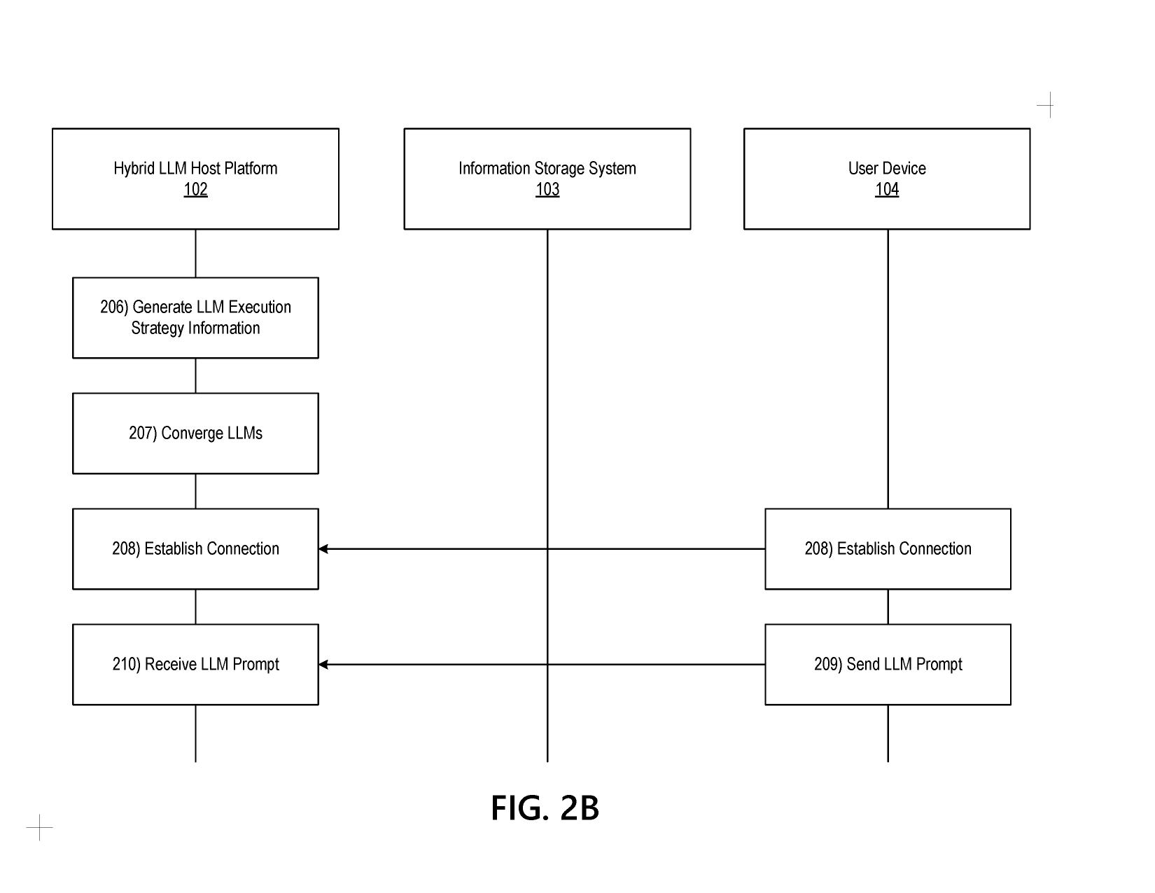

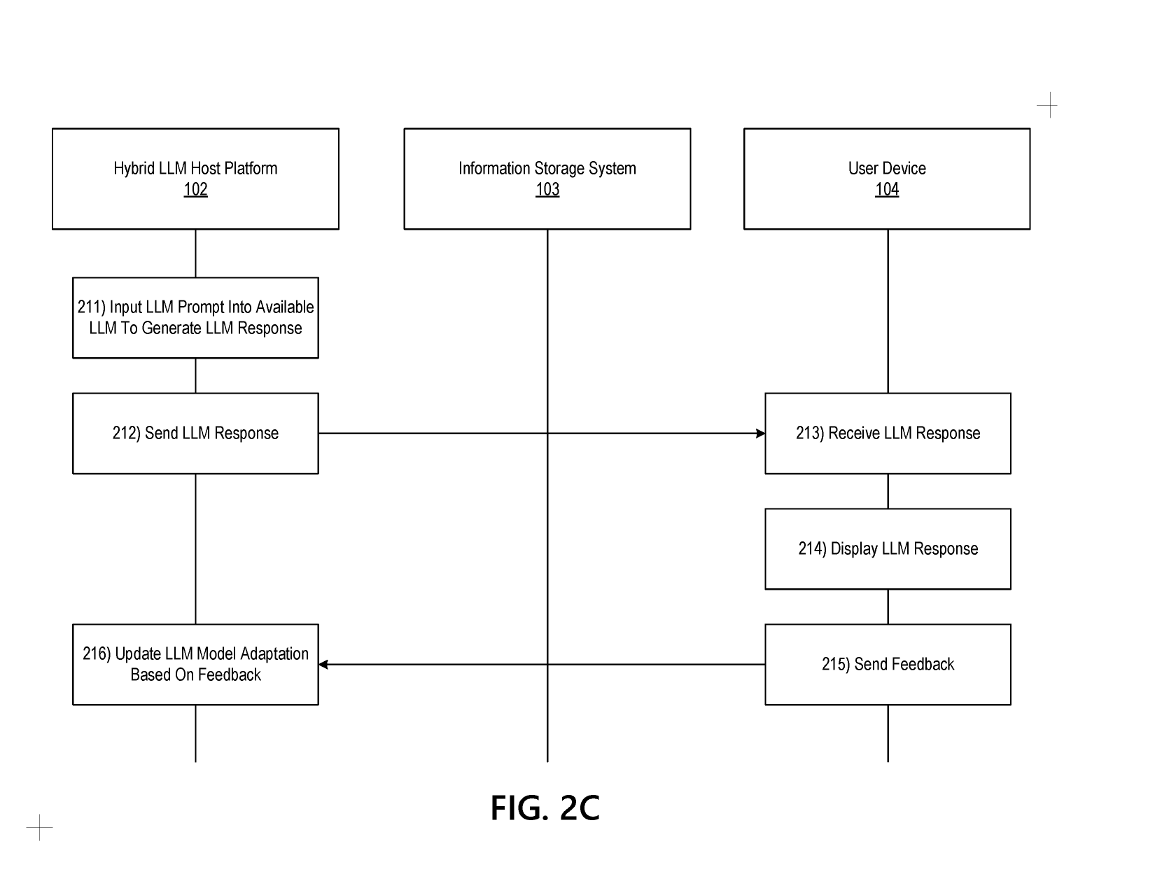

FIGS. 2A-2C depict an illustrative event sequence for tuning hyper-parameters in generative AI models using a hybrid LLM in accordance with one or more example embodiments. Referring to FIG. 2A, at step 201, the information storage system 103 may establish a connection with the hybrid LLM host platform 102. For example, the information storage system 103 may establish a first wireless data connection with the hybrid LLM host platform 102 to link the information storage system 103 with the hybrid LLM host platform 102 (e.g., in preparation for sending information that may be used to train a LLM adaptation model). In some instances, the information storage system 103 may identify whether or not a connection is already established with the hybrid LLM host platform 102. If a connection is already established with the hybrid LLM host platform 102, the information storage system 103 might not re-establish the connection. Otherwise, if a connection is not yet established with the hybrid LLM host platform 102, the information storage system 103 may establish the first wireless data connection as described herein. Although establishing a connection with a single information storage system 103 is illustrated, connections may be established with any number of information storage systems (e.g., model risk management databases, model resource management databases, model lifecycle management databases, model developer information databases, or the like) without departing from the scope of the disclosure.

At step 202, hybrid LLM host platform 102 may request training information for a LLM adaptation model from the information storage system 103. For example, the hybrid LLM host platform 102 may send a request for the training information via the communication interface 113 and while the first wireless data connection is established. In some instances, rather than requesting the training information, the training information may simply be sent to the hybrid LLM host platform 102 as described at step 203 below.

At step 203, the information storage system 103 may send training information to the hybrid LLM host platform 102. For example, the information storage system 103 may send model specific resource information, such as model risk management information (e.g., how models were built, what type of data is used to train the models, model maintenance information, or the like), model resource management information (e.g., where data came from, data parameters, or the like), model lifecycle management information (e.g., how a model was developed, how the model shifted/drifted, or the like), model developer notes, model developer communications, model developer meeting notes, model developer posts, model type information, model data information (e.g., including volume, limits, and/or other information of the data), hyper-parameter optimization schemes, parameter values, iteration increment information, convergence criteria, and/or other information that may be used to inform the training of future models (e.g., LLMs, AI models, or the like). In some instances, the information storage system 103 may send the training information to the hybrid LLM host platform 102 while the first wireless data connection is established.

At step 204, the hybrid LLM host platform 102 may receive the training information sent at step 203. For example, the hybrid LLM host platform 102 may receive the training information via the communication interface 113 and while the first wireless data connection is established.

At step 205, the hybrid LLM host platform 102 may train a LLM adaptation model. For example, the hybrid LLM host platform 102 may train the LLM adaptation model to produce LLM execution strategy information indicating, for a given type of model to be trained, lessons learned that may be used to improve efficiency of the training process and/or accuracy of the model itself (particularly as relates to hyper-parameter optimization of the model). For example, the LLM adaptation model may be trained to produce the types of optimization schemes to be used for hyper-parameter optimization, initial sets of parameters, increments at which each parameter should be changed in each iteration, convergence criteria, and/or other information.

In some instances, to perform such training, the LLM adaptation model may use the training information received at step 204. For example, the hybrid LLM host platform 102 may feed the training information into the LLM adaptation model to establish stored correlations between types of models, the information being processed by those models, and the LLM execution strategy information (e.g., lessons learned that may be applied in training similar models).

In some instances, in training the LLM adaptation model, the hybrid LLM host platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

In some instances, in training the LLM adaptation model, the hybrid LLM host platform 102 may adapt a foundational model that may be a closed loop model, dynamically updated model, and/or other model such as a LLM, AI model, ML model, or the like.

Referring to FIG. 2B, at step 206, the hybrid LLM host platform 102 may produce LLM execution strategy information. For example, the hybrid LLM host platform 102 may feed model information (e.g., a type of model to be trained, what type of information/data is being used by the model, volume of the data, limits of the data, and/or other information) into the LLM adaptation model. Based on this model information, the LLM adaptation model may identify stored correlations with LLM execution strategy information (e.g., to identify lessons learned that may be used to train the type of model input into the LLM adaptation model). For example, the LLM adaptation model may produce types of optimization schemes to be used for hyper-parameter optimization, initial sets of parameters, increments at which each parameter may be changed in each iteration, convergence criteria, and/or other information.

At step 207, the hybrid LLM host platform 102 may train and/or otherwise converge the model (e.g., the model indicated for training at step 206) based on the LLM execution strategy information. For example, the hybrid LLM host platform 102 may host a foundational model, which may, e.g., be a LLM, AI model, ML model, and/or other model, which may be configured with data associated with a number of topics, applications, tasks, or the like, and which may, e.g., be adapted to create one or more particular models, that may be configured to perform specialized tasks such as question answering, sentiment analysis, information extraction, image captioning, object recognition, instruction following, and/or other tasks. In order to train these particular models, the hybrid LLM host platform 102 may use the LLM execution strategy information.

For example, the hybrid LLM host platform 102 may train/converge the particular models by using the identified type of optimization scheme for hyper-parameter optimization. Additionally or alternatively, the hybrid LLM host platform 102 may train/converge the particular model using the identified set of initial parameters. Additionally or alternatively, the hybrid LLM host platform 102 may train/converge the particular model by modifying the initial parameters in training iterations according to the identified increments. Additionally or alternatively, the hybrid LLM host platform 102 may train/converge the particular model based on the identified convergence criteria. In some instances, the hybrid LLM host platform 102 may train/converge a first model using a first portion of the LLM execution strategy information, and a second model using a second portion of the LLM execution strategy information. In some instances, the first and second portions may be entirely different, have partial overlap, and/or be the same.

In doing so, the hybrid LLM host platform 102 may make the process of converging the particular model more efficient, as well as make the resulting model more accurate. For example, the LLM execution strategy information may inform the training of the particular model at each training iteration, so as to train the particular model in a way that may result in a more accurate model rather than a less accurate model (which may e.g., have been produced if the hybrid LLM host platform 102 pursued a different convergence path). For example, the use of the LLM execution strategy information may reduce a likelihood of flawed convergence for the particular model (e.g., particularly as compared to convergence of the particular model without use of the LLM execution strategy information). Additionally, as the particular model progresses along different steps of iterations, the model may be further updated with different rules, and if the strategy diverges significantly from the expected behavior indicated by the LLM execution strategy information, the particular model may be updated according to the LLM execution strategy information. Particularly, by converging the particular model according to the LLM execution strategy information, the hybrid LLM host platform 102 may produce/identify a solution space for the particular model (e.g., through hyperparameter optimization), which may, e.g., be more accurate than a solution space that may be produced (e.g., likewise through hyperparameter optimization), without the use of the LLM execution strategy information. For example, in instances where the LLM execution strategy information is not used in convergence, the hybrid LLM host platform 102 may produce a first solution space for a particular model, which may, e.g., include a plurality of solutions that may, e.g., be associated with a particular level of accuracy (e.g., despite the execution of hyper-parameter optimization within that first solution space). In comparison, where the LLM execution strategy information is used in convergence, the hybrid LLM host platform 102 may produce a second solution space for the particular model, which may, e.g., include a plurality of solutions that may, e.g., be associated with a higher level of accuracy. Thus, when the hyper-parameter optimization is performed within the second solution space, the solution may be associated with a higher level of accuracy than a solution identified through hyper-parameter optimization within the first solution space. This may provide a technical benefit of increased accuracy, reduced error rates, or the like for the resulting models that are trained/converged according to the LLM execution strategy information.

In some instances, this technique may be used to converge/train one or more different particular models (e.g., LLMs, ML models, AI models, or the like). For example, different models may be trained to perform different tasks such as question answering, sentiment analysis, information extraction, image captioning, object recognition, instruction following, and/or other tasks, generating human-like text, searching and retrieving information, summarizing text, performing classification, understanding natural language and answering questions, analyzing sentiment, filtering content, translating language, assisting with computer code, generating content for creative applications, and/or other functions based on the LLM prompt. In some instances, this LLM may have been trained on a representation of training data to generate new content that may be similar to or inspired by existing data, and that may include human-like outputs such as natural language text, source code, images/videos, audio samples, and/or other outputs.

At step 208, the user device 104 may establish a connection with the hybrid LLM host platform 102. For example, the user device 104 may establish a second wireless data connection with the hybrid LLM host platform 102 to link the user device 104 to the hybrid LLM host platform 102 (e.g., in preparation for sending LLM prompts). In some instances, the user device 104 may identify whether or not a connection is already established with the hybrid LLM host platform 102. If a connection is already established with the hybrid LLM host platform 102, the user device 104 might not re-establish the connection. If a connection is not yet established with the hybrid LLM host platform 102, the user device 104 may establish the second wireless data connection as described herein.

At step 209, the user device 104 may send an LLM prompt to the hybrid LLM host platform 102. For example, the user device 104 may send a prompt configured for input into an LLM hosted by the hybrid LLM host platform 102, such as the particular LLM trained/converged at step 207. As a particular example, the user device 104 may enable a user to interact with a chatbot hosted by the hybrid LLM host platform 102 and/or otherwise, and the LLM prompt may request a response by the chatbot. For example, the user device 104 may send the LLM prompt to the hybrid LLM host platform 102 while the second wireless data connection is established. Although depicted as being sent to the hybrid LLM host platform 102, in some instances, the LLM prompt may be sent to a different computing system hosting the LLM (i.e., the LLM may be hosted by another system different than the hybrid LLM host platform 102).

At step 210, the hybrid LLM host platform 102 may receive the LLM prompt sent at step 209. For example, the hybrid LLM host platform 102 may receive the LLM prompt via the communication interface 113 and while the second wireless data connection is established.

Referring to FIG. 2C, at step 211, the hybrid LLM host platform 102 may produce a LLM response. For example, the hybrid LLM host platform 102 may feed the LLM prompt into the particular LLM trained/converged at step 207. For example, the hybrid LLM host platform 102 may use the particular LLM to generate human-like text, search and retrieve information, summarize text, perform classification, understand natural language and answer questions, analyze sentiment, filter content, translate language, assist with computer code, generate content for creative applications, and/or other perform other functions based on the LLM prompt.

At step 212, the hybrid LLM host platform 102 may send a LLM response to the user device 104. For example, the hybrid LLM host platform 102 may send the LLM response to the user device 104 via the communication interface 113 and while the second wireless data connection is established. In some instances, the hybrid LLM host platform 102 may also send one or more commands directing the user device 104 to display the LLM response.

At step 213, the user device 104 may receive the LLM response sent at step 212. For example, the user device 104 may receive the LLM response while the second wireless data connection is established. In some instances, the user device 104 may also receive the one or more commands directing the user device 104 to display the LLM response.

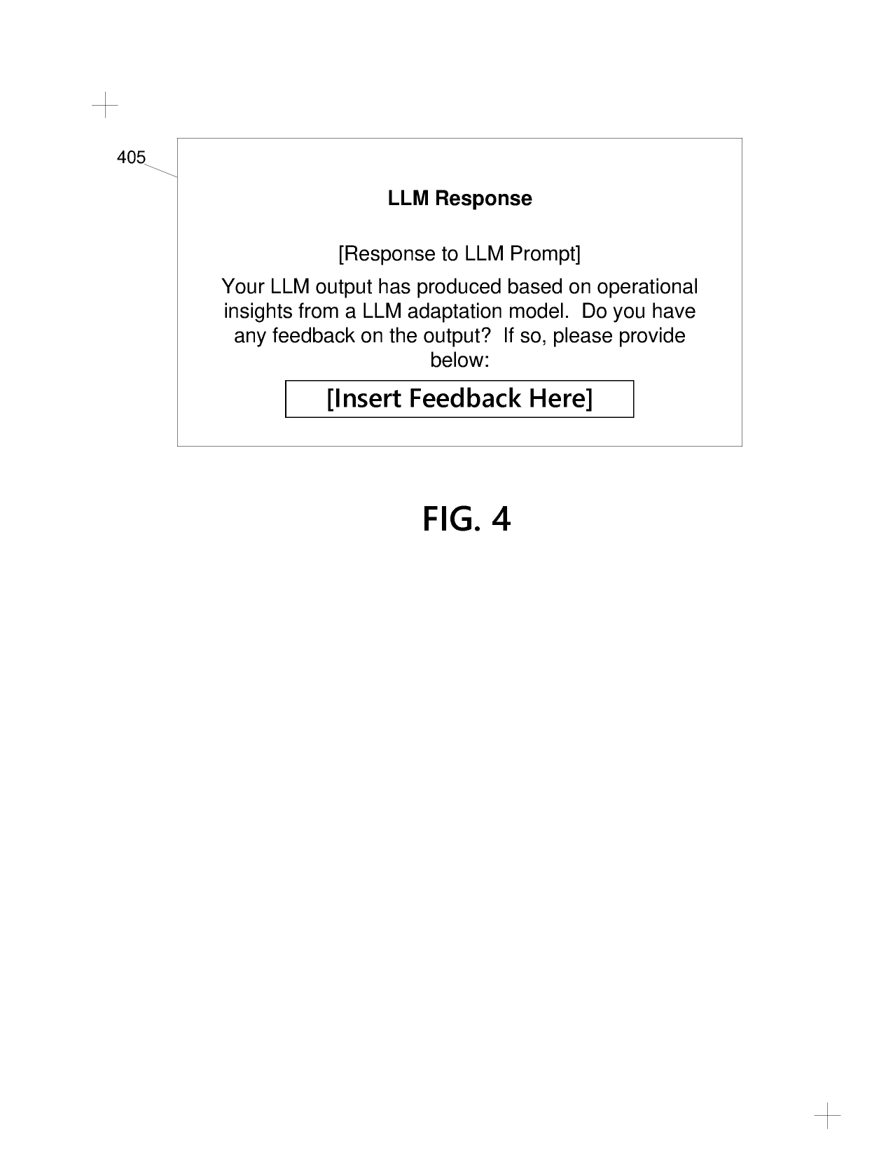

At step 214, based on or in response to the one or more commands directing the user device 104 to display the LLM response, the user device 104 may display the LLM response. For example, the user device 104 may display a graphical user interface similar to graphical user interface 405, which is shown in FIG. 4. For example, the user device 104 may display a response to the users LLM prompt, along with an indication that the output was generated based on operational insights, lessoned learned, and/or other information produced by a LLM adaptation model. In some instances, the LLM response may prompt for any feedback information associated with content provided in the response.

At step 215, the user device 104 may send feedback information to the hybrid LLM host platform 102. For example, the user device 104 may send the feedback information to the hybrid LLM host platform 102 while the second wireless data connection is established.

At step 216, the hybrid LLM host platform 102 may receive the feedback information from the user device 104. For example, the hybrid LLM host platform 102 may receive the feedback information via the communication interface 113 and while the second wireless data connection is established.

The hybrid LLM host platform 102 may update the LLM adaptation model based on the feedback information. For example, the hybrid LLM host platform 102 may identify, based on the feedback information, that an error rate associated with the outputs of one or more of the particular LLMs, AI models, ML models, and/or other models have exceeded a predetermined error threshold. Based on this determination, the hybrid LLM host platform 102 may identify that the corresponding LLMs, AI models, ML models, or the like should be retrained. To perform such retraining, the hybrid LLM host platform 102 may obtain updated training information for the LLM adaptation model and update the LLM adaptation model accordingly (e.g., by performing steps similar to those described above with regard to steps 202-205). Once the LLM adaptation model has been updated, information of the particular models to be retrained, the feedback information, and/or other information may be fed into the LLM adaptation model to produce updated LLM execution strategy information (e.g., by performing actions similar to those described above with regard to step 206). Once this LLM execution strategy information is generated, it may be used to retrain the particular models accordingly (e.g., by performing actions similar to those described above at step 207). In doing so, hybrid LLM host platform 102 may continue to refine the LLM adaptation model, and/or other models (e.g., models trained based on the insights produced by the LLM adaptation model) using a dynamic feedback loop, which may, e.g., increase the accuracy and effectiveness of the LLM adaptation model in producing insights that may be used to train additional models and/or the models themselves in producing LLM outputs. For example, hybrid LLM host platform 102 may reinforce, modify, and/or otherwise update the LLM adaptation model and/or other particular models thus causing the models to continuously improve.

In some instances, in addition or as an alternative to updating the LLM adaptation model and/or other models based on detecting that the error threshold has been exceeded, the hybrid LLM host platform 102 may update these models in a preventative manner (e.g., updating the models at a predetermined interval, or the like), predictive manner (e.g., based on predicting that the error rate will soon exceed the error threshold, despite not yet exceeding), and/or otherwise.

In some instances, the hybrid LLM host platform 102 may continuously refine the models. In some instances, the hybrid LLM host platform 102 may maintain an accuracy threshold for the LLM adaptation model and/or other models, and may pause refinement (through the dynamic feedback loops) of the models if the corresponding accuracy is identified as greater than the corresponding accuracy threshold. Similarly, if the accuracy fails to be equal or less than the given accuracy threshold, the hybrid LLM host platform 102 may resume refinement of the model through the dynamic feedback loop.

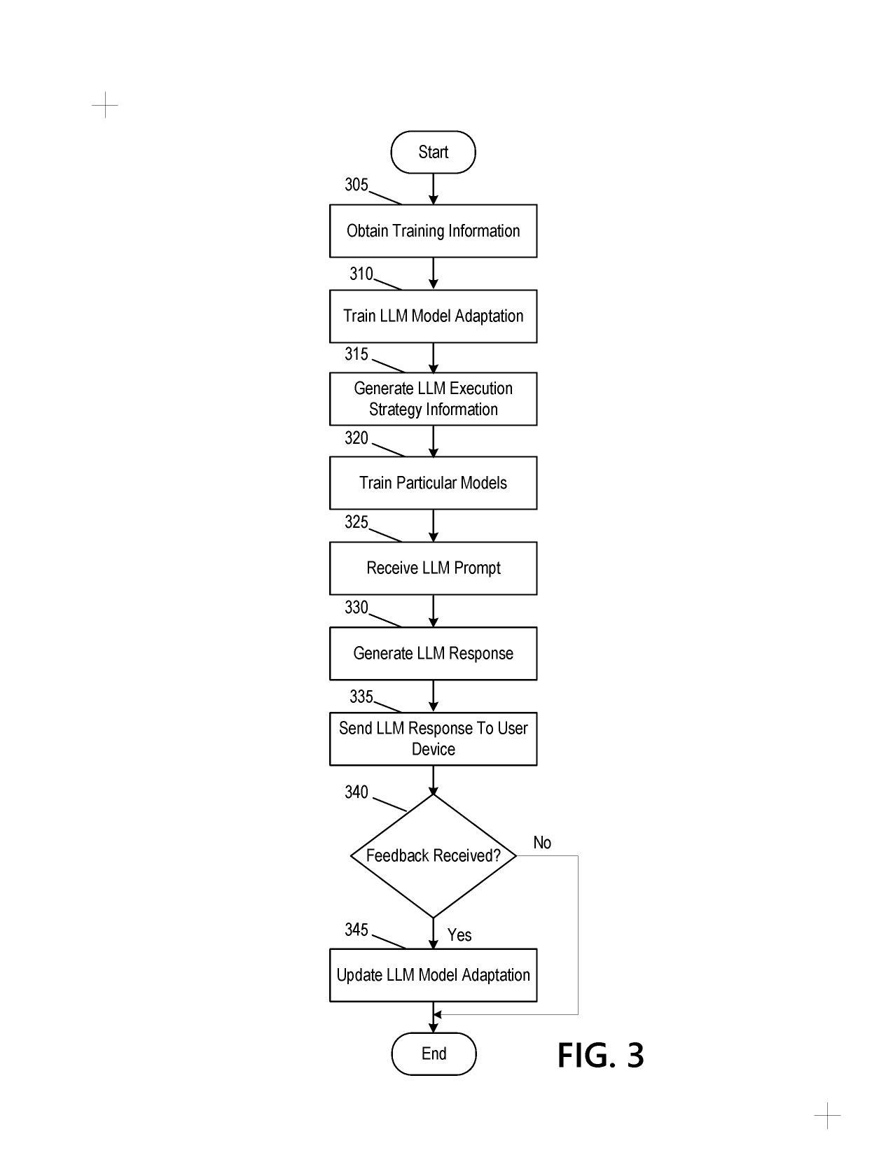

FIG. 3 depicts an illustrative method for tuning hyper-parameters in generative AI models using a hybrid LLM in accordance with one or more example embodiments. Referring to FIG. 3, at step 305, a computing platform comprising one or more processors, memory, and a communication interface may obtain training information that may be used to train an adaptation of a foundational LLM model to produce insights that may be used to train other models. At step 310, the computing platform may train the LLM adaption model based on the training information. At step 315, the computing platform may use the trained LLM adaptation model to produce LLM execution strategy information (e.g., the insights that may be used to train other models). At step 320, the computing platform may train particular models based on the LLM execution strategy information. At step 325, the computing platform may receive a LLM prompt. At step 330, the computing platform may input the LLM prompt into one of the particular models to generate a LLM response. At step 335, the computing platform may send the LLM response to a user device. At step 340, the computing platform may identify whether any feedback was received from the user device. If feedback was received, the computing platform may proceed to step 345 to update the LLM model adaptation and/or other models based on the feedback. Otherwise, if no feedback is received, the method may end.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using model management information, a large language model (LLM) adaptation model, wherein training the LLM adaptation model configures the LLM adaptation model to produce LLM execution strategy information including one or more of: optimization schemes for hyper-parameter optimization, initial sets of parameters, increments at which each parameter would be changed in each iteration, or convergence criteria;
train, based on the LLM execution strategy information, a target model type, and target model information, a LLM, wherein training the LLM comprises converging the LLM by performing hyper-parameter optimization based on the LLM execution strategy information to select a solution space;
receive, from a user device, a LLM prompt;
input, into the LLM, the LLM prompt, wherein inputting the LLM prompt into the LLM causes the LLM to produce a LLM response; and
send, to the user device, the LLM response and one or more commands directing the user device to display the LLM response, wherein sending the one or more commands directing the user device to display the LLM response causes the user device to display the LLM response.

2. The computing platform of claim 1, wherein the model management information comprises model risk management information, model resource management information, model lifecycle management information, model developer notes, model developer communications, model developer meeting notes, or model developer posts.

3. The computing platform of claim 1, wherein the LLM execution strategy information includes one or more of: optimization schemes for hyper-parameter optimization, initial sets of parameters, increments at which each parameter would be changed in each iteration, or convergence criteria.

4. The computing platform of claim 1, wherein the LLM comprises a specialized LLM, trained based on a foundational LLM.

5. The computing platform of claim 4, wherein the LLM execution strategy information is used to inform convergence of a plurality of LLMs, in addition to the LLM, based on the foundational LLM.

6. The computing platform of claim 5, wherein the memory stores additional computer readable instructions that, when executed by the at least one processor, cause the computing platform to:
receive feedback associated with performance of one or more of: the plurality of LLMs or the LLM;
identify, based on the feedback, that an error rate of one or more of: the plurality of LLMs or the LLM exceeds an error threshold;
execute the LLM adaptation model to produce updated LLM execution strategy information; and
retrain, using the updated LLM execution strategy information, one or more of: the plurality of LLMs or the LLM.

7. The computing platform of claim 1, wherein training the LLM using the LLM execution strategy information comprises training, based on a first portion of the LLM execution strategy information the LLM, wherein at least one additional LLM of a plurality of LLMs is trained based on a second portion of the LLM execution strategy information, different than the first portion.

8. The computing platform of claim 1, wherein the target model information comprises one or more: types of information being used to train the LLM, a volume of the information being used to train the LLM, or limits of the types of information being used to train the LLM.

9. The computing platform of claim 1, wherein training the LLM based on the LLM execution strategy information reduces a likelihood of flawed convergence of the LLM when compared to training of the LLM without use of the LLM execution strategy information.

10. The computing platform of claim 1, wherein training the LLM based on the LLM execution strategy information improves accuracy of solution space identification, wherein the hyper-parameter optimization is performed within the identified solution space, and wherein performance of the hyperparameter optimization within the identified solution space reduces a likelihood of errors generated by the LLM when compared to performance of the hyperparameter optimization within other solution spaces identified without use of the LLM execution strategy information.

11. A method comprising:
at a computing platform comprising at least one processor, a communication interface, and memory:
training, using model management information, a large language model (LLM) adaptation model, wherein training the LLM adaptation model configures the LLM adaptation model to produce LLM execution strategy information including one or more of: optimization schemes for hyper-parameter optimization, initial sets of parameters, increments at which each parameter would be changed in each iteration, or convergence criteria;
training, based on the LLM execution strategy information, a target model type, and target model information, a LLM, wherein training the LLM comprises converging the LLM by performing hyper-parameter optimization based on the LLM execution strategy information to select a solution space;
receiving, from a user device, a LLM prompt;
inputting, into the LLM, the LLM prompt, wherein inputting the LLM prompt into the LLM causes the LLM to produce a LLM response; and
sending, to the user device, the LLM response and one or more commands directing the user device to display the LLM response, wherein sending the one or more commands directing the user device to display the LLM response causes the user device to display the LLM response.

12. The method of claim 11, wherein the model management information comprises model risk management information, model resource management information, model lifecycle management information, model developer notes, model developer communications, model developer meeting notes, or model developer posts.

13. The method of claim 11, wherein the LLM execution strategy information includes one or more of: optimization schemes for hyper-parameter optimization, initial sets of parameters, increments at which each parameter would be changed in each iteration, or convergence criteria.

14. The method of claim 11, wherein the LLM comprises a specialized LLM, trained based on a foundational LLM.

15. The method of claim 14, wherein the LLM execution strategy information is used to inform convergence of a plurality of LLMs, in addition to the LLM, based on the foundational LLM.

16. The method of claim 15, further comprising:
receiving feedback associated with performance of one or more of: the plurality of LLMs or the LLM;
identifying, based on the feedback, that an error rate of one or more of: the plurality of LLMs or the LLM exceeds an error threshold;
executing the LLM adaptation model to produce updated LLM execution strategy information; and
retraining, using the updated LLM execution strategy information, one or more of: the plurality of LLMs or the LLM.

17. The method of claim 11, wherein training the LLM using the LLM execution strategy information comprises training, based on a first portion of the LLM execution strategy information the LLM, wherein at least one additional LLM of a plurality of LLMs is trained based on a second portion of the LLM execution strategy information, different than the first portion.

18. The method of claim 11, wherein the target model information comprises one or more: types of information being used to train the LLM, a volume of the information being used to train the LLM, or limits of the types of information being used to train the LLM.

19. The method of claim 11, wherein training the LLM based on the LLM execution strategy information reduces a likelihood of flawed convergence of the LLM when compared to training of the LLM without use of the LLM execution strategy information.

20. One or more non-transitory computer-readable media storing instructions that, when executed by a computing platform comprising at least one processor, a communication interface, and memory, cause the computing platform to:
train, using model management information, a large language model (LLM) adaptation model, wherein training the LLM adaptation model configures the LLM adaptation model to produce LLM execution strategy information including one or more of: optimization schemes for hyper-parameter optimization, initial sets of parameters, increments at which each parameter would be changed in each iteration, or convergence criteria;
train, based on the LLM execution strategy information, a target model type, and target model information, a LLM, wherein training the LLM comprises converging the LLM by performing hyper-parameter optimization based on the LLM execution strategy information to select a solution space;
receive, from a user device, a LLM prompt;
input, into the LLM, the LLM prompt, wherein inputting the LLM prompt into the LLM causes the LLM to produce a LLM response; and
send, to the user device, the LLM response and one or more commands directing the user device to display the LLM response, wherein sending the one or more commands directing the user device to display the LLM response causes the user device to display the LLM response.
